(19) United States
(12) Patent Application Publication
(10) Pub. No.: US 2024/0165852 A1
(43) Pub. Date: May 23, 2024

(54) THREE-DIMENSIONAL PRINTING PROCESSES, FUSED DEPOSITION MODELING (FDM) MATERIALS, FILAMENTS, AND INKS, AND ASSOCIATED METHODS

(71) Applicant: Purdue Research Foundation, West Lafayette, IN (US)

(72) Inventors: Cole Matthew Maynard, Lafayette, IN (US); Julio Andres Hernandez, West Lafayette, IN (US); Brittany Ann Newell, Delphi, IN (US); Tyler Nash Tallman, West Lafayette, IN (US); Jose Manuel Garcia-Bravo, West Lafayette, IN (US)

(21) Appl. No.: 18/313,841

(22) Filed: May 8, 2023

Related U.S. Application Data
(60) Provisional application No. 63/338,965, filed on May 6, 2022.

(51) Int. Cl. B29B 9/12; B29C 64/118; B29C 64/205; B29K 105/12; B29K 275/00; B29K 507/04; B29L 31/34; B33Y 10/00; B33Y 70/10; B33Y 80/00

(52) U.S. Cl. CPC B29B 9/12; B29C 64/118; B29C 64/205; B33Y 10/00; B33Y 70/10; B33Y 80/00; B29K 2105/124; B29K 2275/00; B29K 2507/04; B29L 2031/3406

(57) ABSTRACT

Wet-mixing process, electrically-conductive fused deposition modeling material, 3D printable fused deposition modeling (FDM) filament, electrically-conductive ink, and associated methods. A wet mixing process includes dissolving a thermoplastic with a solvent, thereby creating a thermoplastic-based solution, suspending conductive carbon nanofibers (CNFs) in the thermoplastic-based solution, and mixing the thermoplastic-based solution to distribute the CNFs throughout the solution. The solvent may be evaporated from thermoplastic-based solution to form an electrically-conductive FDM material having a solid matrix of the thermoplastic with CNFs dispersed homogenously throughout the solid matrix. A 3D printable fused deposition modeling filament may be formed of the FDM material. An electrical circuit component may be additively manufactured with a 3D printer and the FDM material. An electrically-conductive ink may be formed from the thermoplastic-based solution.

### CROSS-REFERENCE TO RELATED APPLICATIONS

This application claims the benefit of U.S. Provisional Application No. 63/338,965, filed May 6, 2022, the contents of which are incorporated herein by reference.

### STATEMENT REGARDING FEDERALLY SPONSORED RESEARCH

This invention was made with government support under grant number N00174-19-1-0016 awarded by the Office of Naval Research. The government has certain rights in the invention.

### BACKGROUND OF THE INVENTION

The invention generally relates to three-dimensional (3D) printing processes, materials, and equipment. The invention particularly relates to fused deposition modeling (FDM) 3D printing processes, FDM materials, 3D printable FDM filaments, inks, and methods of making and/or using the same in FDM 3D printing processes.

Additive manufacturing (AM) has seen growth within hobbyist and educational environments and within commercial aerospace and manufacturing industries. This trend is expected to continue as more advanced materials are developed. Fused filament fabrication (FFF), also known as fused deposition modeling (FDM) and filament freeform fabrication, is a 3D printing process that uses a continuous filament. The ability to reliably employ a customized filament in a 3D printing process is highly dependent on three components: the homogeneity of the material being used, consistent geometric properties of the filament, and the correct printer setup and settings. Once these criteria are met, the potential application areas of AM are nearly limitless. One type of FDM filament material that has the potential to create a notable change is electrically-conductive materials, which may in some cases be used to manufacture reliably consistent electrical circuit components with a 3D printer. An electrically-conductive filament is often referred to as a multifunctional material due to its capability of being used as a structural element while also possessing the ability to conduct electricity. Within potential applications, this type of multifunctional FDM material may prove to be invaluable given its self-sensing capabilities through the piezoresistive effect. The piezoresistive effect is a result of the conductive filler that is used within multifunctional materials, assuming that the filler is well dispersed, and the material is homogeneous.

While commercially available multifunctional FDM filaments exist, they often exhibit some unwanted variability between spools, especially those containing materials from different manufacturing batches, in addition to lacking the ability to be modified to meet application specific needs. Therefore, a method of producing adaptable homogeneous multifunctional filaments is needed to meet specific needs of various users. The ability to produce and customize such materials would allow for multifunctional additive manufacturing to become more widely adopted within both the private and commercial sectors.

Previous efforts to produce customizable homogeneous multifunctional filaments have utilized a dry-mixing process to initially disperse conductive particles throughout a base thermoplastic. This dry-mixing process involves the agitation of raw conductive nanoparticles and a pelletized base thermoplastic without the use of any mediums. After the dry nanoparticles are dispersed, the material is subjected to sequential melt-mixing cycles to produce a homogeneous material using a three-stage single screw extruder. The resulting filament, while being electrically-conductive and exhibiting consistent electrical properties, can experience thermal degradation through this type of manufacturing process, in part due to the melt-mixing cycles required to disperse the conductive particles. This filament degradation may be visually observable and manifest itself as inconsistent surface geometries and the presence of voids within the internal structure of the extruded filament.

In view of the above, it would be desirable if manufacturing processes were available that were capable of producing more usable and consistent FDM materials, particularly multifunctional filaments including electrically-conductive FDM materials, as well as 3D printable FDM filaments and inks.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, fused deposition modeling (FDM) 3D printing processes, FDM materials (including electrically-conductive FDM materials), 3D printable FDM filaments, inks (including electrically-conductive inks), and methods of making and/or using the same to produce, as nonlimiting examples, electrical circuit components.

According to a nonlimiting aspect of the invention, method of manufacturing an electrically-conductive fused deposition modeling (FDM) material includes wet mixing conductive carbon nanofibers (CNFs) and a thermoplastic (TP) in a liquid solvent to form an evenly mixed suspension of the CNFs in a liquid thermoplastic/solvent solution, and evaporating the solvent out of the evenly mixed suspension to form the electrically-conductive FDM material containing the CNFs homogeneously mixed within a solid matrix of the thermoplastic.

According to another nonlimiting aspect of the invention, a method of manufacturing an electrically-conductive filament includes forming the electrically-conductive filament from the electrically-conductive FDM material manufactured as described above.

According to other nonlimiting aspects of the invention, an electrically-conductive FDM material includes a solid matrix of a thermoplastic and conductive carbon nanofibers (CNFs) dispersed homogenously throughout the solid matrix. An elongate strand of the electrically-conductive FDM material may be used to produce a 3D printable fused deposition modeling filament. Furthermore, an electrical circuit component can be produced to contain the electrically-conductive FDM material, such as additively manufacturing the electrical circuit component from the electrically-conductive FDM material using a 3D printer.

According to another nonlimiting aspect of the invention, an electrically-conductive ink is provided that includes a semi-cured CNF/thermoplastic mixture formed at least in part from the evenly mixed suspension of the CNFs in the liquid thermoplastic/solvent solution manufactured as described above. Additionally, a method of printing is provided that includes printing the electrically-conductive ink from a syringe-pump-based printer.

According to another nonlimiting aspect of the invention, a wet-mixing process that disperses conductive carbon nanofibers (CNFs) throughout a thermoplastic includes dissolving the thermoplastic with a solvent to create a thermoplastic-based solution, suspending the CNFs in the thermoplastic-based solution, and mixing the thermoplastic-based solution to distribute the CNFs throughout the solution.

Technical aspects of processes, methods, materials, filaments, components, and inks as described above preferably include the capability of producing FDM materials, devices, and/or components, including electrically-conductive (multifunctional) FDM materials, filaments, and inks that may be formulated to be suitable for use in additive manufacturing of reliably consistent electrical circuit components. Electrically-conductive FDM filaments are preferably capable of being 3D printed to specific electrical conductivities that can be altered to meet specific demands of a particular user. Such FDM materials, filaments, and inks offer the possibility of eliminating the need for multiple melt-mixing cycles, producing a more homogeneous FDM material prior to undergoing extrusion, and improving or optimizing an initial dispersion of nanoparticles throughout an FDM material such that subsequent melt-mixing cycles beyond a first extrusion yield little or no additional benefit to the electrical properties of a FDM filament manufactured therefrom.

Other aspects and advantages will be appreciated from the following detailed description.

### BRIEF DESCRIPTION OF THE DRAWINGS

FIG. 1 schematically represents a wet-mixed carbon nanofiber (CNF)-modified material manufacturing process capable of producing a mixture of CNFs and thermoplastic (TP) according to certain nonlimiting aspects of the invention.

FIGS. 2A and 2B contain images depicting the impact of mixture sonication on the visible presence of CNF agglomerations in CNF/thermoplastic mixtures produced by a wet-mixed CNF-modified material manufacturing process.

FIG. 3 is a graph plotting measured diameters of three CNF/thermoplastic material batches across two subsequent extrusion cycles.

FIG. 4 is a graph plotting measured resistivity of the three CNF/thermoplastic material batches of FIG. 3 across the two subsequent extrusion cycles in addition to that of a commercially available conductive filament, PI-ETPU.

FIGS. 5A and 5B contain images depicting results of print testing to assess the usability of the three CNF/thermoplastic material batches of FIGS. 3 and 4 across the two subsequent extrusion cycles, and show simple single layer dog-bone shaped sensors produced from the batches to assess the reliability of producing multiple components within a single print.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of the embodiment(s) to which the drawings relate. The following detailed description also describes certain investigations relating to the embodiment(s) depicted in the drawings, and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite what at least provisionally are believed to be aspects of the invention, including certain but not necessarily all of the aspects and alternatives described in the detailed description.

According to preferred aspects of the invention, a manufacturing method utilizing a wet mixing process is capable of producing fused deposition modeling (FDM) materials, including electrically-conductive FDM materials, a particular example of which is a homogeneous FDM material referred to herein sometimes as a carbon nanofiber (CNF)-modified thermoplastic (TP) material. In such a process, a thermoplastic-based solution is preferably produced using a solvent to dissolve a thermoplastic and thereby form a liquid thermoplastic/solvent solution. CNFs are then admixed with the thermoplastic/solvent solution to form a suspension in the solution, which is then mixed in order to distribute and preferably evenly disperse the suspended CNFs throughout the solution and yield a CNF/thermoplastic mixture. Thereafter the solvent may be removed from the CNF/thermoplastic mixture to form a solid or semi-solid electrically-conductive FDM material. Once the solvent is fully removed to transform the CNF/thermoplastic mixture to a solid state, one or more additional processes can be carried out on the resulting CNF-modified thermoplastic FDM material to form electrically-conductive components. In one example, the FDM material can be introduced to a single screw extruder to undergo an extrusion process that transforms the FDM material into a form that can be used within 3D printers, as an example, a 3D printable filament.

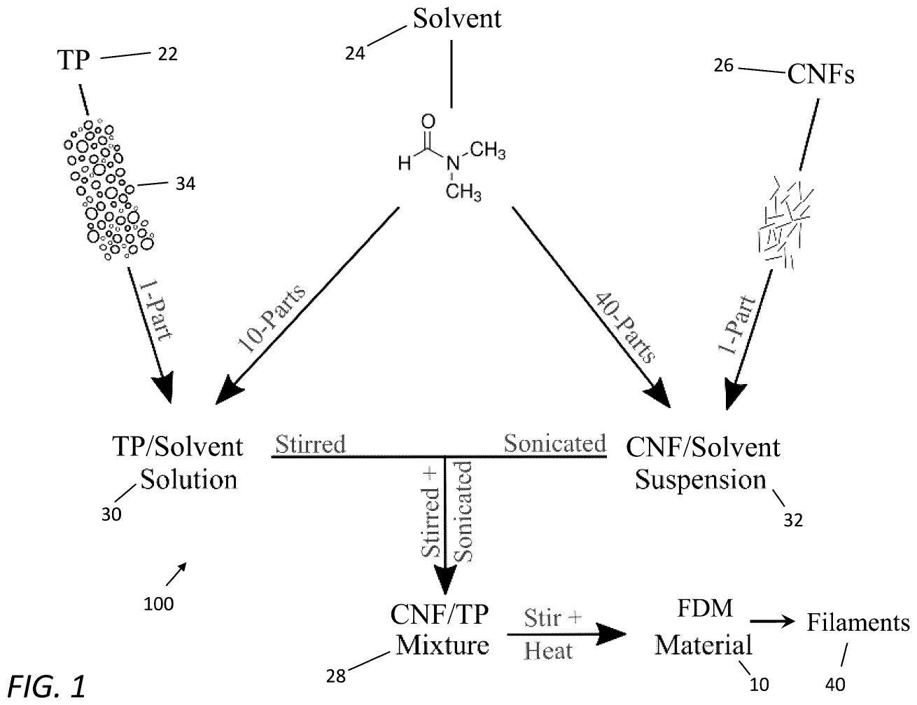

With reference to FIG. 1, a nonlimiting example is shown of a method 100 that can be used to form an electrically-conductive FDM material 10. The method 100 entails wet mixing conductive carbon nanofibers (CNFs) 26, a thermoplastic (TP) 22, and a liquid solvent 24 (represented in FIG. 1 as dimethylformamide (DMF)) to form a CNF/thermoplastic mixture 28 comprising an evenly mixed suspension of the CNFs 26 in a homogeneous liquid thermoplastic/solvent solution 30. The thermoplastic/solvent solution 30 is represented in FIG. 1 as being formed by combining the thermoplastic 22 and a first volume of the liquid solvent 24, and a CNF/solvent suspension 32 is represented in FIG. 1 as being formed by combining the CNFs 26 and a second volume of the liquid solvent 24, which can then be combined with the thermoplastic/solvent solution 30 to form the CNF/thermoplastic mixture 28. Forming the thermoplastic/solvent solution 30 may comprise mixing and preferably dissolving discrete pellets 34 of the thermoplastic 22 in the liquid solvent 24 to form the liquid thermoplastic/solvent solution 30. Prior to being combined with the CNF/solvent suspension 32, the thermoplastic/solvent solution 30 may be stirred to promote the homogeneousness of the solution 30. Prior to being combined with the thermoplastic/solvent solution 30, the CNF/solvent suspension 32 may be mixed, for example by sonicating, to promote an even distribution of the suspended CNFs 26 throughout the suspension 32. After the CNF/solvent suspension 32 and the thermoplastic/solvent solution 30 are combined, the CNF/thermoplastic mixture 28 may be sonicated to promote an even distribution of the suspended CNFs 26 throughout the mixture 28. As a nonlimiting example, the CNFs 26 and the thermoplastic 22 are combined in the mixture 28 at a ratio of about 5% by weight to about 10% by weight of the CNFs 26 relative to the thermoplastic 22, though lesser and greater CNF/thermoplastic ratios are possible. Additionally, it is foreseeable that solvents other than DMF could be used.

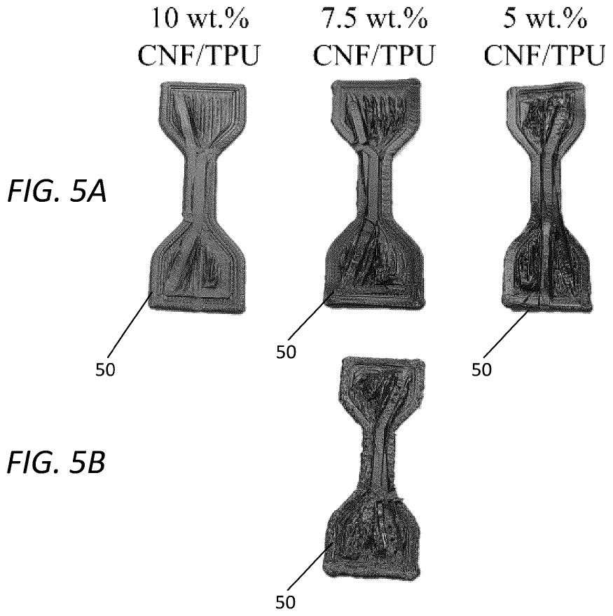

After wet mixing, FIG. 1 represents the CNF/thermoplastic mixture 28 being transformed into an electrically-conductive FDM material 10 containing the CNFs 26, which are preferably dispersed within a solid matrix formed of the thermoplastic 22 by evaporating the solvent 24 out of the CNF/thermoplastic mixture 28. More preferably, the electrically-conductive FDM material 10 has the structure of a solid matrix of the thermoplastic 22 in which the CNFs 26 are homogeneously dispersed. The electrically-conductive FDM material 10 can be subsequently used to form one or more electrically-conductive filaments 40, which in turn may be used as 3D printable filaments in a 3D printer to perform an additive manufacturing process capable of yielding various types of products, components and devices, as a nonlimiting example, electrical circuit components 50 shown in FIGS. 5A and 5B. To do this, the FDM material 10 may be pelletized in any suitable manner to form discrete pellets of the material 10, after which the filaments 40 may be formed from the pellets, for example by a melt extrusion process. Preferably, the filaments 40 can be formed as elongate strands of the FDM material 10. A 3D printer may then use the filament 40 as feedstock to form a product, component, or device by additive manufacturing. In the nonlimiting example of FIGS. 5A and 5B, the components 50 are each configured as a sensor, more particularly, a dog-bone sensor.

It is foreseeable that a wide variety of products, components, and devices may be manufactured in a similar manner from the CNF/thermoplastic mixture 28. One such product is an electrically-conductive ink that may be formed at least in part of a viscous semi-cured form of the CNF/thermoplastic mixture 28, optionally combined with a flexible material, for example, silicone. Such an electrically-conductive ink may also be used in a printing process, as a nonlimiting example, a method that involves printing the electrically-conductive ink by dispensing the ink from a syringe-pump-based printer or other suitable printer.

Nonlimiting embodiments of the invention will now be described in reference to experimental investigations leading up to the invention.

The following investigations can be broken down into multiple phases. First, methods are described for producing a CNF-modified thermoplastic material as an example of a FDM material such as indicated as produced by the wet mixing process represented in FIG. 1. These investigations explored the production of a thermoplastic-based solution (such as the thermoplastic/solvent solution 30 of FIG. 1) from a thermoplastic and an appropriate solvent, the dispersion of CNFs throughout the thermoplastic-based solution to produce a CNF-modified thermoplastic solution (such as the CNF/thermoplastic mixture 28 of FIG. 1), and then the removal of the solvent from the CNF-modified thermoplastic solution to yield the CNF-modified thermoplastic material. Thereafter, a second phase can be carried out to produce solid filaments or viscous inks from the FDM material. In the investigations, CNF-modified thermoplastic materials were introduced to a single screw extruder utilizing manufacturing parameters that were found to be optimal within previous investigations. The extrusion process allows for the material to be transformed into one which can be universally used within FDM 3D printers. Throughout the extrusion process, random sections of the produced filament were electrically measured to characterize the material and the impact that the wet-mixing process might have.

The customized CNF-modified filament within this investigation, was made up using a base thermoplastic urethane (TPU) material of NinjaFlex (NinjaTek, Manheim, PA, USA). This TPU type is a commonly used and readily available material which is regularly used to produce flexible 3D printed components with use cases in the sports, healthcare, and even the manufacturing industries. The specific TPU that was used, NinjaFlex, has a shore hardness value of 85A (ASTM D2240) and has a claimed elongation of 660% at its breaking point (ASTM D638).

Using TPU as a solute, a solution was produced using dimethylformamide (DMF). Specifically, N,N-Dimethylformamide (HCON(CH3)2, 99.8%) was used (Thermo Fisher Scientific, Waltham, MA, USA). To transform the TPU into a multifunctional material, Pytograf-III PR-24-XT-HHT un-functionalized CNFs (Applied Sciences Inc., Cedarville, OH, USA) were used.

A wet mixing process was investigated as it not only shows the potential of more thoroughly mixing components, but this process may also prevent the separation of the CNF/TPU mixture, which has been a challenge in other investigations that used a dry-mixing process. The wet-mixing process appears to eliminate or reduces this challenge and allows for the CNFs to become fully integrated within the TPU material, an advantage which allows for a more homogeneous material to be produced prior to extruding the material into a 3D printable filament.

To produce the DMF/TPU solution, un-modified TPU first was pelletized. TPU pellets were desired to allow the solvent to dissolve the TPU solute more efficiently. The filament was chopped into pellets which ranged from about two to about five millimeters in length. Given the size of the un-modified NinjaFlex filament, which was the base TPU material used, the pellets exhibited a manufacturer specified diameter of 1.75 millimeters.

After being pelletized, the TPU was separated into fourths and gradually mixed throughout a measured amount of DMF, adding only one fourth of the pelletized TPU at a time. The DMF/TPU mixture was produced using 10 milliliters of DMF for every gram of pelletized TPU, a 10:1 volume to weight ratio. Using a Corning PC-420D hot plate/stirrer (Corning Incorporated Life Sciences, Tewksbury, MA, USA), the mixture was stirred for six hours, allowing one and a half hours to elapse after each of the four TPU sub-batches were added. Incrementally adding the TPU mitigated it from clumping together as it began to soften and dissolve. Overall, the six-hour mixing time ensured that all TPU was fully dissolved, thus producing a homogeneous DMF/TPU solution that CNFs could be dispersed throughout. Before adding the CNFs to the DMF/TPU solution, the carbon fiber nanoparticles were suspended within DMF to produce a DMF/CNF suspension. This allowed for a uniform mixing process when added into the DMF/TPU solution compared to adding raw CNF powder to the homogeneous solution. The suspension was initially stirred using a Corning PC-420D hot plate/stirrer as the CNFs were gradually added into the DMF. Specifically, this suspension was produced at a 40:1 volume to weight ratio, where 40 milliliters of DMF were used for every gram of added CNFs. After all CNFs were fully saturated, the suspension was sonicated for two hours before being mixed into the TPU-based solution. To blend the suspension and the solution, the homogeneous DMF/TPU solution was magnetically stirred while the sonicated suspension was gradually added. To ensure the CNFs were fully dispersed throughout the TPU-based solution, the mixture was then sonicated for an additional two additional hours before heat was applied to evaporate the DMF. Sonication was used throughout the mixing process to break up and disperse any CNF agglomerations which may have formed.

After the CNFs were dispersed throughout the base thermoplastic, the solvent used to suspend the CNFs and keep the TPU in a liquified state was evaporated. Evaporating the DMF allows for the CNF-modified TPU solution to return to a solid state. To achieve this, the CNF-modified TPU mixture was heated to 100° C. in a dry bead bath for 24 hours. While being heated, the mixture was stirred using an overhead stirrer to allow for uniform heating of the mixture and prevent the unlikely occurrence of any unwanted precipitation. As the DMF evaporated and the viscosity of the mixture increased, the overhead stirrer was removed, and the mixture was poured from the beaker it was produced within into a nine-inch by nine-inch Pyrex dish. The larger dish allowed for the surface area of the mixture to be maximized, thus aiding in evaporating the DMF and facilitating easier processing of the material after it was fully cured. Specifically, the overhead stirrer was removed when total volume of the mixture, compared to at the start of the solvent evaporation process, had been reduced by 75%.

To ensure all DMF was evaporated at the end of the 24-hour period, the mass of the CNF-modified TPU was compared to the mass of the raw TPU and CNFs used to produce the material. This comparison ensures that the added mass of the DMF is no longer present within the mixture, therefore demonstrating a complete evaporation of the solvent. To ensure that all DMF was removed, a ±5% tolerance was used to compare the overall mass of the CNF-modified TPU to that of the raw components. This tolerance accounts for the potential of environmental changes such as humidity, variations in measurement equipment, and losses from transferring the mixed materials throughout the different phases of the initial mixing process.

To transform the CNF-modified TPU into monofilament, a three-stage single screw extruder was utilized. The extrusion process allowed for 3D printable FDM filament to be produced at a specific size, based upon the diameter of the extruder's nozzle. In this case, the material was extruded at 1.75 millimeters. Before the material could be extruded, it was chopped into uniform pellets that could be fed through the hopper of the extruder. This is an additional reason as to why the material was solidified in a relatively thin layer that maximized the surface area within the solvent evaporation process. Once pelletized, the material was extruded into usable filament batches. Each manufactured filament batch was electrically characterized by randomly selecting and removing twenty-five specimens from the extruded material throughout the extrusion process. Additionally, a two-meter-long filament sample was removed from each extrusion batch to understand the potential of the material in 3D printing applications.

After the extruded material was electrically analyzed, the filament was once again pelletized and re-introduced to the extruder. For each material batch, the second extrusion utilized the same parameters used in the first extrusion. This process investigated the impact of a second melt mixing cycle on the measured properties of the CNF-modified TPU. If the wet-mixing process produced a homogeneous material, no advantages should be seen after a second melt-mixing cycle with respect to the electrical conductivity of the material.

The manufacturing parameters used within this investigation are a result of previous works that investigated the optimal manufacturing parameters using a multi-tiered design of experiments (DOE) for a dry-mixed CNF-modified TPU filament. Building off these findings, three separate wet-mixed CNF/TPU batches were analyzed within this investigation. The first wet-mixed CNF/TPU batch was produced using a 10-weight percent (wt. %) infill of CNFs relative to the mass of the TPU, the second batch was produced using a 7.5 wt. % CNF/TPU mixture, and the third investigated a filament produced at 5 wt. %. The three CNF/TPU batches were produced using an identical wet-mixing process, the same extrusion process, and were identically tested throughout the investigation. To fabricate the 3D printable FDM filament and to test the impact that different compositions might have on said filament, the three wet-mixed CNF/TPU batches were manufactured at the same setpoint extrusion temperature. The extrusion temperature was based upon the previous dry-mixed results which pointed at 220° C. as being an optimal extrusion temperature for this type of nanofiller modified material.

To capture the electrical characteristics of the manufactured filament, pre-testing preparation work was conducted on each randomly selected specimen. First, the specimens selected from each manufacturing batch were cut into 125-millimeter-long segments. After being cut to length, electrodes were applied to each specimen. These electrodes were created by applying a 3-millimeter-long layer of conductive fast-drying silver paint to the specimens (Ted Pella, Redding, CA, USA). The electrodes acted as ohmic junctions between the conductive network of CNFs, which were assumed to run uniformly throughout the surface and subsurface of the multifunctional filament, and the equipment used to electrically characterize each specimen.

The resistance of each specimen was captured using a Fluke 45 Dual Display Multimeter (Fluke Corporation, Everett, WA, USA). The resistance value (R) was then converted to resistivity (φ by collecting geometric measurements on each of the specimens. Specifically, three diameter measurements were taken and averaged to calculate the mean cross-sectional area (A) for each specimen, in addition to recoding each specimen's unit length (L). Using equation 1, the geometric values and the measured resistance of each specimen were used to electrically characterize the manufactured material.

ρ=RA/L Equation (1)

In an effort to understand the impact of even a single melt-mixing cycle, the materials' electrical properties were measured prior to being subjected to the first extrusion. This was achieved by cutting the solidified CNF-modified TPU mixture into prismatic sections after the wet-mixing process was completed. Once prismatic specimens were produced, the specimens were prepared and tested in the same way that the extruded specimens were to be tested. Performing these measurements produced a baseline value that could then be used to understand how the melt-mixing process and the composition of material might impact the overall electrical characteristics of the CNF-modified thermoplastic.

After each batch was electrically characterized, a test was performed to assess the printability of the manufactured material. To this end, a 3D printed cube measuring one-centimeter along all axes was attempted. If a successful cube was produced using the manufactured material, the cubes were evaluated qualitatively based upon their surface quality and quantitatively based upon the number of print attempts that were required to produce the cube, with respect to each of the three material types. Furthermore, if the material was able to produce the desired cube, a series of ten single layer type I dog-bone shaped (ASTM D638-14) sensors were produced to assess the reliability of the manufactured filament in producing multiple independent objects within a single print. The exact shape of the printed sensors was selected was arbitrary in context of these investigations.

If the material failed to produce a completed cube, the print test was re-performed up to five times. After five failed attempts, the material was said to have failed the printability testing and was deemed unusable. All 3D printing tests were performed on a LulzBot Taz 6 printer (FAME 3D, Fargo, North Dakota, USA) which utilized a single head extruder with a hardened steel nozzle. The specific print settings used were based upon both manufacturer-recommended values and values which resulted in optimal printability tests within the previously mentioned dry-mixed CNF/TPU experimentation.

Several components were modified throughout the experimentation process. This includes both changes to the specific methods that were used to develop the discussed manufacturing methods, and changes in the process that were originally stated when this investigation was proposed. A list of these summarized changes and the specific ways in which the changes were made can be seen in Table 1.

In all, twenty small-scale experiments were carried out to reach the refined manufacturing method proposed within this report. These small-scale experiments were used to solidify the manufacturing methods used to investigate the impacts of material composition and the extrusion process. It should be noted that only once the manufacturing process was fully solidified, was the first experimental batch of material produced; no changes to the developed manufacturing process were made between any of the three material batches discussed.

TABLE 1
Changes to Manufacturing Methods and Proposed Investigation Process.
Changes from the Original Experimental Procedures

| | | Previous | | Refined | |
|---|---|---|---|---|---|
| Changed Component | | Method/Process | | Method/Process | |
| Process | Material weight | 10 | wt. % Material batch | 10 | wt. % Material batch |
| | fractions | 7.5 | wt. % Material batch | 7.5 | wt. % Material batch |
| | | | | 5 | wt. % Material batch |
| | Filament | 215° | C. Material batch | 220° | C. Material batch |
| | extrusion | 220° | C. Material batch | | |
| | temperatures | 225° | C. Material batch | | |

| | Printability | N/A | Printed cubes (Ext. 1-2) |
|---|---|---|---|
| | testing | | Printed sensors (Ext. 1-2) |
| Methods | TPU Solution | 50% DMF | 100% DMF |
| | | Concentration | Concentration |
| | CNF | 20:1 Ratio of | 40:1 Ratio of |
| | Suspension | DMF to CNFs | DMF to CNFs |
| | Solution | Stirring | Stirring and |
| | mixing | | sonication |
| | Suspension | Sonication | Stirring and |
| | mixing | | sonication |
| | TPU mixing | 8 Hours | 6 Hours |
| | time | (all at once) | (piecewise) |
| | CNF/TPU | Stirring | Stirring and |
| | Mixing | | sonication |

| | | |
|---|---|---|
| Solvent | Hotplate | Dry bead bath (in-house) |
| evaporation | (heat only) | Overhead stirrer (in-house) |
| Evaporation | Foil pan w/ | Beaker (0-75% evap.) |
| container | release film | Glass dish (70-100% evap.) |

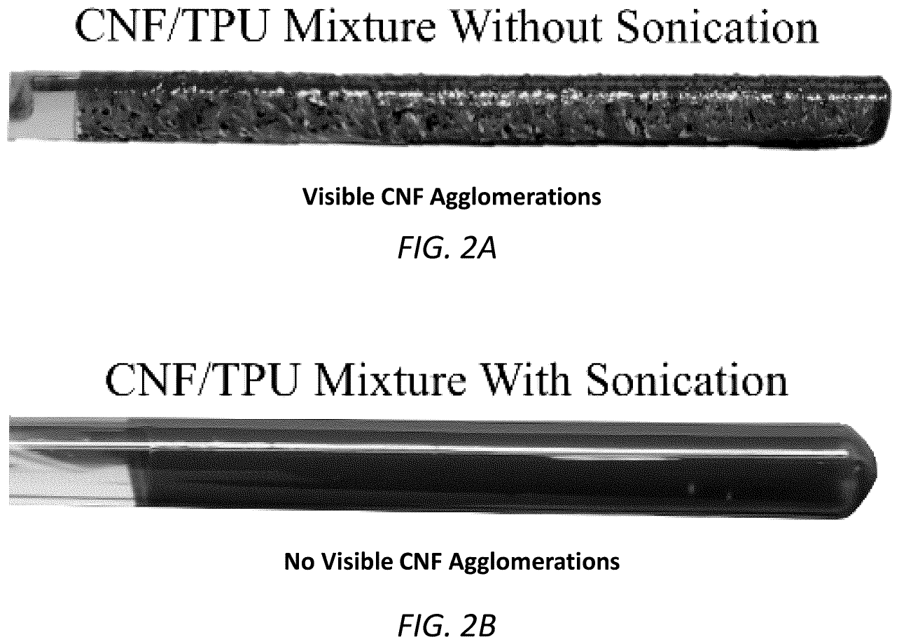

Based upon the wet-mixing process previously described, material batches were produced at 10, 7.5, and 5 wt. % CNF/TPU compositions. These three batches were produced in small quantities, utilizing 50 grams of TPU for each material batch. FIG. 1 depicts the steps developed within this manufacturing process. Within this process, sonication to break up any CNF agglomerations was found to be very advantageous. FIGS. 2A and 2B highlight the impact of the sonication process on the resulting CNF/TPU mixture.

After the DMF had been fully evaporated, the resulting material was electrically characterized. To do so, 12 rectangular specimens were cut from each batch and their exact dimensions recorded. After the geometric measurements were taken, fast-drying silver paint electrodes were applied to each end of the rectangular specimens. Utilizing a the two-point probe measurement method, each of the rectangular specimens were electrically characterized for all three material batches. The results of this characterization can be seen within Table 2. The recorded values show that the material manufactured at the two highest concentrations of CNFs, 10 wt. % and 7.5 wt. %, exhibited both a standard deviation and resistivity value that were each roughly three orders of magnitude lower than that of the 5 wt. % material. While improvements were expected to be seen within these criteria, the substantial increase in resistivity and standard deviation suggest that the percolation threshold for the 5 wt. % material, based upon the materials and manufacturing methods used, is being approached. Future investigations looking at 6.25, 3.75, and 2.5 wt. % CNF-modified TPU materials will help further this understanding.

TABLE 2
Electrical characterization of three wet-mixed CNF-modified
TPU material batches prior to being extruded.
Wet-Mixed CNF-Modified TPU Electrical Characterization

| | Mean | Resistivity | Measured |
|---|---|---|---|
| | Resistivity | Std. Dev. | Specimens |
| Wt. % | [Ω cm] | [Ω cm] | (out of 12) |
| 10 | 2.33 | 0.45 | 12 |
| 7.5 | 6.67 | 0.59 | 12 |
| 5 | 3002.96 | 6674.58 | 12 |

After the manufactured material was electrically characterized and chopped into pellets that could be fed through the filament extruder, the three material batches were extruded into a 3D printable FDM filament. Each batch was extruded at 220° C. twice, and twenty-five specimens were randomly selected from each extrusion to be electrically characterized after the first and second extrusions. Only the 10 wt. % and the 7.5 wt. % materials could be extruded within both extrusion attempts. The 5 wt. % material failed to produce a viable filament within the second extrusion, therefore results are only reported for this material composition from the first extrusion. Without wishing to be bound by theory, the cause of the extrusion failure may have been related to thermal degradation of the material.

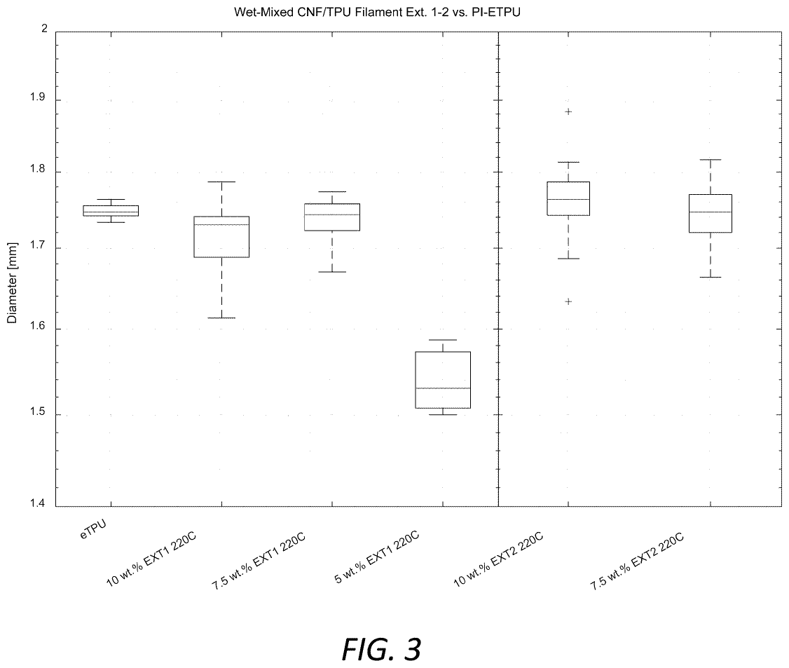

FIG. 3 shows the results of measuring the geometric properties of the randomly selected specimens through each extrusion. Nominally, the diameter of the extruded filament should be 1.75 millimeters as dictated by the diameter of the extrusion nozzle. While deviation from this nominal diameter was expected, the closer the material could be extruded to this value, the greater likelihood that it could be used to reliably produce 3D printed components. It was found that after the first extrusion, the measured diameter of the extruded filament had a greater variation between specimens and a larger mean error from that of the nominal diameter. Overall, the best material, based solely upon the geometric measures performed on the extruded filament, was found to be the 7.5 wt. % CNF/TPU material after the first extrusion. Compared to previously performed dry-mixed CNF/TPU investigations, the filament manufactured across all three material compositions was found to maintain the desired diameter more closely and had an overall lower standard deviation, except for the 5 wt. % CNF/TPU batch which failed to produce viable filament in the second extrusion process.

Additively manufacturing components via FDM is typically dependent on the constant flow of material through the print nozzle. If voids exist within the filament or inconsistencies on the surface of the filament impact the material flow rate, it is possible that the desired 3D printed component will either fail or have undesired defects. Therefore, as an additional way of evaluating the extruded material, the cross section and surface structure of randomly selected specimens were recorded for each resulting filament batch. Ideally, the extruded filament would appear smooth on the surface and be free of voids throughout the interior structure. Based upon the results, it can be seen that after the first extrusion, all three wet-mixed material types appeared to have a smooth and uniform surface and contain no visible voids throughout the internal structure of the filaments. However, after the second extrusion, extensive porosity issues can be seen throughout the cross section in addition to a diminished surface quality for the two successfully produced filament batches. Therefore, while filament can still be produced for the 7.5 and 10 wt. % CNF/TPU material batches after two subsequent extrusion cycles, it is believed that the material and geometric properties of the filaments are optimal after the first extrusion process.

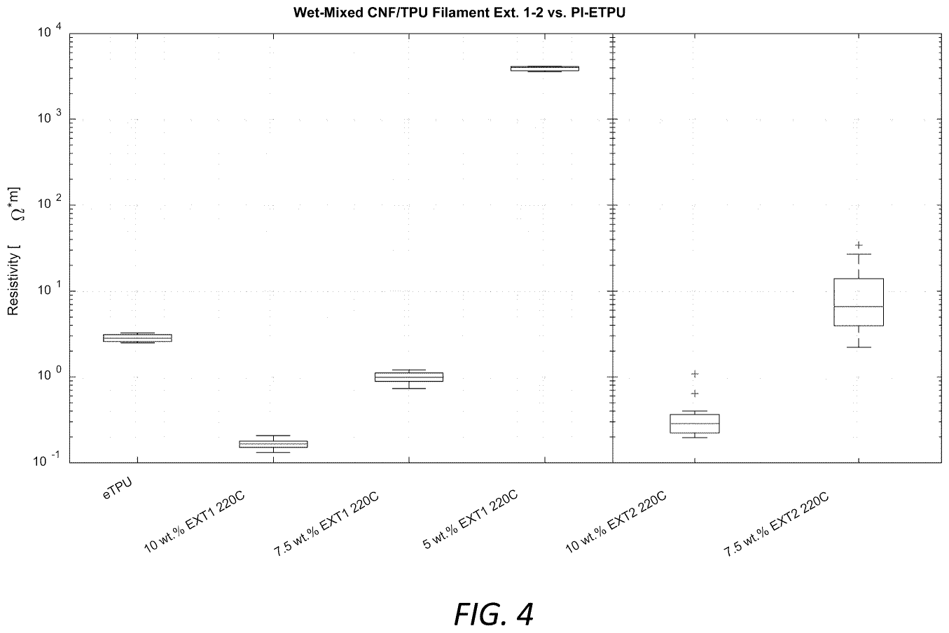

The ability to achieve consistent electrical measurements across an entire batch of extruded filament is believed to be dependent on the uniform dispersion of CNFs throughout the material. Consistent electrical property is relevant when 3D printing sensor like conductive components. Any variability in the electrical properties of a filament will translate to components reacting and behaving in significantly different ways. Even when looking at commercially available conductive filaments such as PI-ETPU Carbon Black (Palmiga Innovation, Jonstorp, SE), the manufacturer specified variation in filament resistivity varied by nearly two orders of magnitude. To evaluate the electrical properties of the wet-mixed CNF/TPU material, each of the 25 randomly selected specimens from each successful extrusion were electrically characterized. Additionally, sample specimens were collected from a spool of the commercially available conductive PI-ETU carbon black filament and electrically characterized following the same process previously outlined. The inclusion of this commercially available filament allowed for a direct comparison between the developed manufacturing process which resulted in the three wet-mixed CNF/TPU filament types, and that of a product which is amongst the most regularly used conductive filaments on the market, specifically relating to the resulting electrical properties and uniformity. The results gathered for each of these manufacturing batches, in addition the measured resistivity for the commercially available conductive TPU filament can be seen in FIG. 4.

Based upon the electrical characterization results, several observations can be made. First, the mean resistivity of both the 10 wt. % and 7.5 wt. % CNF/TPU material was found to be less than that of the commercially available filament. This was true of the 10 wt. % material through both extrusions but the resistivity of the 7.5 wt. % material surpassed the resistivity of the PI_ETPU material after the second extrusion. Secondly, a trend similar to what was seen when the manufactured material was electrically characterized in the first extrusion can be seen after the first extrusion. This helps to illustrate that the extrusion process did not appear to have any adverse effects on only one specific material type, and that all three materials were equally impacted electrically by being extruded. Specifically, the three materials each experienced roughly an 85-100% increase in electrical resistivity as a result of the first extrusion. The second extrusion increased the resistivity of the 7.5 wt. % CNF/TPU material by an additional 90% while the 10 wt. % CNF/TPU material only experienced a 50% increase in resistivity within the second extrusion. Lastly, the measured standard deviation of the 7.5 wt. % and the 10 wt. % CNF/TPU materials were lower than that of the commercially available filament after the first extrusion. This shows that the 10 wt. % and 7.5 wt. % CNF/TPU were not only more conductive than the commercially available conductive TPU, but they also exhibited greater specimen to specimen consistency with respect to the measured resistivity for the sample mean. Because a second extrusion for the 5 wt. % CNF/TPU material was unable to be successfully performed as the material was unable to maintain its cylindrical form as it exited the extruder, no electrical characterization data was able to be captured for this extrusion batch. Table 3 contains the data gathered throughout the electrical characterization process for both the manufactured CNF-modified TPU and the extruded CNF/TPU filament.

TABLE 3
Electrical characterization data for the wet-mixed CNF/TPU material
across the three investigated infills. The data includes the electrical
characterization of the material post manufacturing in addition to
after the first and second extrusion processes.
Wet-mixed CNF-Modified TPU Electrical Characterization Results

| | | | Avg. | Avg. | Resistivity | |
|---|---|---|---|---|---|---|
| CNF/TPU | | | Resistance | Resistivity | Std. Dev. | Measurable |
| Mixture | | Material | [Ω] | [Ω cm] | [Ω cm] | Specimens |
| — | | PI-ETPU | 151609.1667 | 284.1789 | 26.0855 | 12/12 |
| | | Filament | | | | |
| 10 | wt. % | Wet- | 117.1081 | 2.3322 | 0.4670 | 12/12 |
| 7.5 | wt. % | Mixed | 251.0667 | 6.6690 | 0.6115 | 12/12 |
| 5 | wt. % | Material | 9053.4167 | 3002.9662 | 6971.3743 | 12/12 |
| 10 | wt. % | Wet- | 8782.3200 | 16.4449 | 1.8863 | 25/25 |
| 7.5 | wt. % | Mixed | 55349.6000 | 99.0114 | 12.9692 | 25/25 |
| 5 | wt. % | Filament | 287433333.0000 | 392588.2266 | 29929.2948 | 3/25 |
| | | 220° C. | | | | |
| | | Extrusion 1 | | | | |
| 10 | wt. % | Wet- | 16602.3200 | 32.9182 | 18.5299 | 25/25 |
| 7.5 | wt. % | Mixed | 531022.6923 | 993.4387 | 820.8179 | 25/25 |
| 5 | wt. % | Filament | — | — | — | — |
| | | 220° C. | | | | |
| | | Extrusion 2 | | | | |

Regardless of the electrical or geometric values exhibited by a manufactured filament, if the material is unable to be used within a 3D printing application, then it is deemed unusable. To assess this, each of the extruded filament batches were allotted five attempts at producing a cube measuring one centimeter along all axes. If the cube was unable to be produced after five attempts, the material was determined to have failed the printability test. If a completed cube is produced within the five attempts, the material was said to have passed the printability test. If a material passed the printability test, a secondary assessment was performed to better understand the reliability of utilizing the material to produce multiple components within a single print. FIGS. 5A and 5B display the dog-bone shaped single layer sensors that were used to assess the reliability of the material to produce multiple components.

As a result of the printability testing, it was determined that materials which underwent only a single extrusion were able to be printed with greater ease. Without wishing to be bound by theory or these specific test results, the 7.5 wt. % CNF/TPU material appeared to be the optimal material to produce components based upon the quality of the printed components. Furthermore, the 7.5 wt. % material was the only filament which was able to successfully complete the printability test after the second extrusion process. The second-best material from an ease of use and quality of the resulting components perspective, appeared to be the 10 wt. % material. All three filament types were able to successfully produce the printed cubes after the first extrusion. Additionally, each of these three filaments were able to produce all ten of the single layer dog-bone shaped sensors successfully on the first attempt, as exemplified in FIG. 5A (first extrusion) and FIG. 5B (second extrusion). This shows the potential of being able to reliably use these wet-mixed materials to precisely produce 3D printed components. Compared to dry-mixed CNF/TPU materials, the printed components manufactured using the wet-mix process described herein appeared to be of higher quality and were also able to be produced with greater reliability.

The solution-based (wet-mix) manufacturing method disclosed herein shows potential to be used to precisely manufacturer multifunctional thermoplastic materials and demonstrates the ability to modify a commercially available dielectric material like TPU to meet very precise metrics. An important consideration for manufacturing multifunctional FDM filaments is the ability to achieve and maintain precise electrical parameters throughout the production of a filament batch, in addition to between similar filament batches. The solution-based mixing method disclosed herein demonstrates the potential to produce conductive 3D printable filaments that exhibit electrical properties that are more consistent than those reported by known commercial filament manufacturers.

Other potential alternative applications for the solution-based mixing (wet-mix) process disclosed herein are foreseeable. For example, a semi-cured and highly viscous CNF/TPU mixture may be utilized within syringe-pump-based printers. The CNF/TPU mixture would act as a conductive ink in this case, which could be utilized within other flexible materials, such as silicon. As a whole, the wet-mix appears to provide a significant advance in the field of additive manufacturing which will allow for an improved ability to tailor multifunctional materials to meet precise needs and/or allow for customizable active 3D printed products. Processes and materials according to the present disclosure may allow a customizable electrically-conductive filament to be produced with greater precision and adaptability than what is currently available, and/or may allow precise and adaptable conductive components to more reliably be produced, which can be used from hobbyist applications to manufacturing environments.

As previously noted above, though the foregoing detailed description describes certain aspects of one or more particular embodiments of the invention, alternatives could be adopted by one skilled in the art. For example, the materials, filaments, components, and their (sub)components could differ in appearance and construction from the embodiments described herein and shown in the drawings, functions of certain (sub)components of the materials and filaments, components could be performed by components of different construction but capable of a similar (though not necessarily equivalent) function, and various materials could be used in the fabrication of the materials, filaments, components, and/or their (sub)components. As such, and again as was previously noted, it should be understood that the invention is not necessarily limited to any particular embodiment described herein or illustrated in the drawings.

1. A method of manufacturing an electrically-conductive fused deposition modeling material, the method comprising:
wet mixing conductive carbon nanofibers (CNFs) and a thermoplastic in a liquid solvent to form an evenly mixed suspension of the CNFs in a liquid thermoplastic/solvent solution; and
evaporating the solvent out of the evenly mixed suspension to form the electrically-conductive fused deposition modeling material containing the CNFs homogeneously mixed within a solid matrix of the thermoplastic.

2. The method of claim 1, wherein the step of wet mixing comprises:
forming the liquid thermoplastic/solvent solution as a homogeneous liquid thermoplastic/solvent solution comprising the thermoplastic and a first volume of the liquid solvent;
adding the CNFs to the homogeneous liquid thermoplastic/solvent solution; and
mixing the CNFs in the liquid thermoplastic/solvent solution to form the evenly mixed suspension.

3. The method of claim 2, wherein the step of forming the homogeneous liquid thermoplastic/solvent solution comprises:
mixing pellets of the thermoplastic in the liquid solvent;
dissolving the mixed pellets in the liquid solvent to form the liquid thermoplastic/solvent solution; and
mixing the resulting liquid thermoplastic/solvent solution to form the homogeneous liquid thermoplastic/solvent solution.

4. The method of claim 1, wherein the step of forming the evenly mixed suspension comprises:
forming a CNF/solvent suspension by suspending the CNFs within a second volume of the liquid solvent; and
adding the CNF/solvent suspension to the homogeneous liquid thermoplastic/solvent solution.

5. The method of claim 4, wherein the step of forming the CNF/solvent suspension includes sonicating the CNF/solvent suspension.

6. The method of claim 1, wherein the step of forming the evenly mixed suspension includes sonicating the suspension.

7. The method of claim 1, wherein the step of wet mixing comprises combining the CNFs and the thermoplastic at a ratio of about 5% to about 10% by weight of CNFs relative to the mass of the thermoplastic.

8. The method of claim 1, wherein the liquid solvent comprises dimethylformamide.

9. A method of manufacturing an electrically-conductive filament, the method comprising forming the electrically-conductive filament from the electrically-conductive fused deposition modeling material of claim 1.

10. The method of claim 9, the method further comprising forming the electrically-conductive fused deposition modeling material into pellets, wherein the step of forming the electrically-conductive filament includes forming the electrically-conductive filament from the pellets.

11. The method of claim 9, wherein the step of forming the electrically-conductive filament includes extruding the electrically-conductive fused deposition modeling material into a 3D printable fused deposition modeling filament.

12. An electrically-conductive fused deposition modeling material comprising:
a solid matrix of thermoplastic; and
conductive carbon nanofibers (CNFs) dispersed homogenously throughout the solid matrix.

13. The electrically-conductive fused deposition modeling material of claim 12, wherein the CNFs and thermoplastic are present in weight percent ratio of about 5% to about 10% by weight of CNFs relative to the mass of the thermoplastic.

14. A 3D printable fused deposition modeling filament comprising an elongate strand of the electrically-conductive fused deposition modeling material of claim 12.

15. A method of manufacturing an electrical circuit component, the method comprising additively manufacturing the electrical circuit component with a 3D printer and the electrically-conductive fused deposition modeling material of claim 12.

16. The method of claim 15, wherein the electrical circuit component comprises a sensor.

17. An electrical circuit component comprising the electrically-conductive fused deposition modeling material of claim 12.

18. The electrical circuit component of claim 17, wherein the electrical circuit component comprises a sensor.

19. An electrically-conductive ink comprising a semi-cured CNF/thermoplastic mixture formed at least in part from the evenly mixed suspension of the CNFs in the liquid thermoplastic/solvent solution of claim 1.

20. The electrically-conductive ink of claim 19, wherein the electrically-conductive ink comprises a flexible silicon material.

21. A method comprising printing the electrically-conductive ink of claim 19 from a syringe-pump-based printer.

22. A wet-mixing process that disperses conductive carbon nanofibers (CNFs) throughout thermoplastic, the process comprising the steps:
dissolving thermoplastic with a solvent, thereby creating a thermoplastic-based solution;
suspending CNFs in the thermoplastic-based solution; and
mixing the thermoplastic-based solution to distribute the CNFs throughout the solution.
